(19) United States
(12) Patent Application Publication
(10) Pub. No.: US 2009/0262126 A1
(43) Pub. Date: Oct. 22, 2009

(54) System and Method for Separated Image Compression

(75) Inventors: Xuan Zhang, San Jose, CA (US); Bin Zhu, Hangzhou (CN)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: TechBridge, Inc.

(21) Appl. No.: 12/425,255

(22) Filed: Apr. 16, 2009

Related U.S. Application Data
(60) Provisional application No. 61/045,545, filed on Apr. 16, 2008.

(51) Int. Cl. G09G 5/00; G09G 5/02

(52) U.S. Cl. 345/582; 345/643; 345/591

(57) ABSTRACT

A method and system for separated image compression are disclosed. According to one embodiment a computer-implemented method comprises initiating transfer of a screen image, preparing the screen image for separation, separating the screen image into image blocks, compressing the image blocks into image packets, and transmitting the image packets.

The present application claims the benefit of and priority to U.S. Provisional Patent Application No. 61/045,545 entitled “Separated Graph/Text Image Compression for Improving Application Sharing and Desktop Sharing Performance” filed on Apr. 16, 2008, and is hereby, incorporated by reference.

### FIELD

The present invention relates generally to the field of computer application and, more specifically, to separated image compression.

### BACKGROUND

Rapid development of computer and network technology bring great convenience to life and work. Virtual space continues to grow. Advances in technology improve accessibility of remote terminals and consoles. For example, using VNC, PCAnywhere and NetMeeting, people can access remote computers as easily as accessing a local machine. In such applications, remote screen synchronization based on image compression and transmission is crucial. Frequent changes of a remote desktop screen cause large amounts of image data to be transferred over a computer network, consuming significant network bandwidth.

Existing methods attempt to reduce large consumption of network bandwidth. In early years, some simple algorithms handled remote screen data, such as Raw, RRE, and Hextile, without compressing data. Significant consumption of bandwidth for transferring data over a network still remained despite the development of such algorithms. Subsequently, two algorithms called ‘Zlib’ and ‘ZlibHex’ were introduced by Tridia VNC. The algorithms encode and compress Raw and Hextile data using standard ‘zlib’ library for further reducing data size. However, the resulting lossless compression does not solve the problem of large bandwidth consumption.

Lossy image compression, such as JPEG, compresses a screen image. The compression greatly reduces data size without significantly impacting the final image quality. The limitation with lossy compression technology is that it compresses natural images that differ from desktop screen images. Desktop screen images compressed by JPEG do not result in high image quality with a high compression ratio at the same time.

A remote desktop image is a graphic image and contains a large amount of text and lines, with extremely sharp outlines. A JPEG encoder has to generate more output to keep the original image quality. Even so, fuzzy output around the outline areas result.

Traditional image compression methods in remote desktop applications do not generate a high-quality image and a high compression ratio at the same time.

### SUMMARY

A method and system for separated image compression are disclosed. According to one embodiment a computer-implemented method comprises initiating transfer of a screen image, preparing the screen image for separation, separating the screen image into image blocks, compressing the image blocks into image packets, and transmitting the image packets.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 is a flow diagram for an exemplary image encoding and compression process within a separated image compression system, according to one embodiment.

FIG. 2 is a block diagram of an exemplary encoded data structure within a separated image compression system, according to one embodiment.

FIG. 3 is a process flow diagram for an exemplary image transmission process within a separated image compression system, according to one embodiment.

FIG. 4 is a flow diagram for an exemplary decoding process within a separated image compression system, according to one embodiment.

FIG. 5 is a flow diagram for establishing a relationship between a user system and a provider within a separated image compression system, according to one embodiment.

FIG. 6 is a system level diagram of users and a provider in an exemplary separated image compression system, according to one embodiment.

FIG. 7 illustrates an exemplary computer architecture for use with the present system, according to one embodiment.

### DETAILED DESCRIPTION

A method and system for separated image compression are disclosed. According to one embodiment a computer-implemented method comprises initiating transfer of a screen image, preparing the screen image for separation, separating the screen image into image blocks, compressing the image blocks into image packets, and transmitting the image packets.

A system for separate image compression separates texts and lines from a screen image. The texts and images can then be compressed separately based on data characteristics. After analyzing the colors and regions of texts and lines, the texts and lines are converted to bi-level textural images and compressed by a bi-level lossless image compressor, such as JBIG.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

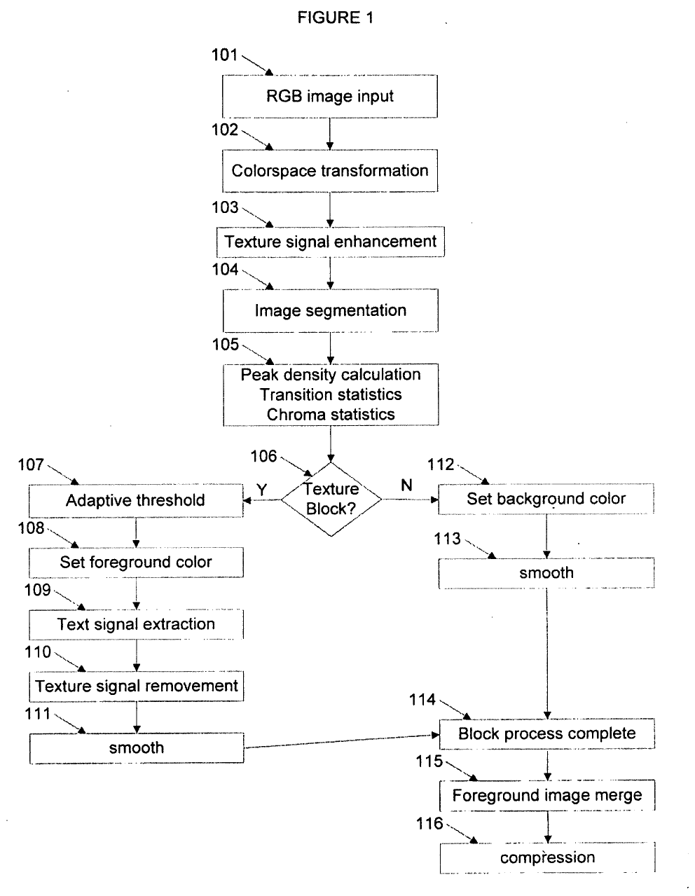

FIG. 1 is a flow diagram for an exemplary image encoding and compression process within a separated image compression system, according to one embodiment. An exemplary process includes preprocessing a screen image, separating the foreground and background of a screen image, processing the foreground image, processing the background image, and compression of both.

An RGB (Red Green Blue) screen image is input 101, and the color image is transformed from RGB to the YUV color space using a linear function 102. The Y-component signal is better for graphic separation because human eyes are more sensitive to the Y-component signal. Also, using the Y-component reduces the amount of processing data as compared to using RGB components. In other embodiments other choices of color space, such as HIS, are used for graphic separating.

Separation efficiency is enhanced by preprocessing the texture signal 103, where a pixel gradient is calculated for the texture signal. This image preprocessing is helpful because the texture signal and background image signal have different characteristics. Because of the relatively strong contrast between the prospect and the background in the texture block, the texture signal can be enhanced when the gradient calculation is carried out, while the background signal can be weakened.

The image is split into small blocks 104 and each block is processed separately and classified into a category. The pixel gradient is calculated so each block has a luminosity transition parameter. The number of transitions is calculated by searching the dramatic brightness changes in a block, and the number is used later in determining whether a block is a texture block. The pixels in a background image block commonly take high chroma, so the block chroma statistics can also aid in determining the block type. Through calculating color and brightness of the pixels in a block, the block can be categorized into low, medium, or high chroma.

Peak density is calculated 105 to determine whether the block belongs to a text block or background image block according to a predetermined threshold. The threshold is related to the number of peaks and troughs in the horizontal and vertical directions of the block.

According to luminosity transition parameters and color statistics, an amendment is made to the block classification 106. After block classification 106, foreground color and background color are separated into texture blocks. According to one embodiment, a separated image compression algorithm evaluates if the foreground and background color of neighbor blocks have been set, and addresses the neighbor blocks first. The adaptive threshold calculation is applied to the texture block 107, and the separation is processed based on the calculated threshold. The MSD (mean squared deviation) of pixels on both sides of the threshold is calculated, the smaller threshold being the foreground pixels.

Foreground color is set by using the mean value of the color of foreground pixels 108, and the foreground image is transformed into a binary image 109. After text extraction, the texture signal remaining in the background image is removed and replaced with the mean value of the non-foreground pixels around it 110. The separated texture block is smoothed 111.

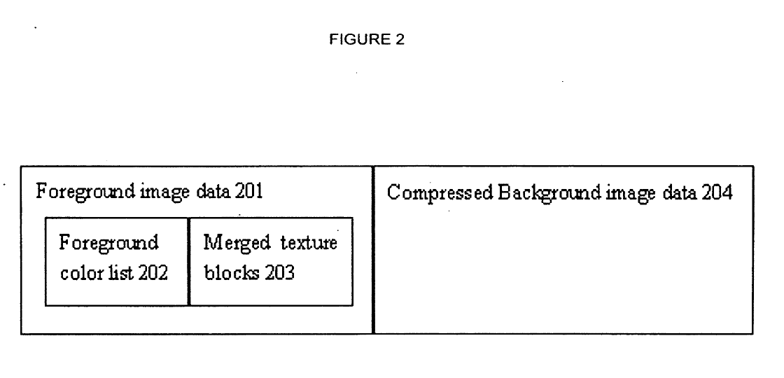

The background color of the background image is set 112. The background image now contains significant noise and sharp edges that have not been removed. The existence of both noise and sharp edges has a negative impact on image compression. To remedy this issue, the background image is smoothed 113 to improve the compression effect. After smoothing 113, the background image is compressed in high ratio by JPEG. When classification and extraction of all blocks are complete 114, the binary image of texture blocks which have the same foreground color are merged 115. The data stream containing the foreground colors and merged binary image data is compressed losslessly 116 and the foreground data stream and background data stream are packed into a structure, an example of such structure is shown in FIG. 2.

FIG. 2 is a block diagram of an exemplary encoded data structure within a separated image compression system, according to one embodiment. An image data structure has a foreground image data section 201, and a background image data section 204. The foreground image data section 201 has a foreground color list 202 and merged texture blocks data 203. The foreground color list 202 contains the number of foreground colors and the RGB value of each color. The merged texture blocks data 203 stores every merged texture block data by the order of the color list 202. The compressed background image data section 204 contains compressed JPEG data, according to one embodiment.

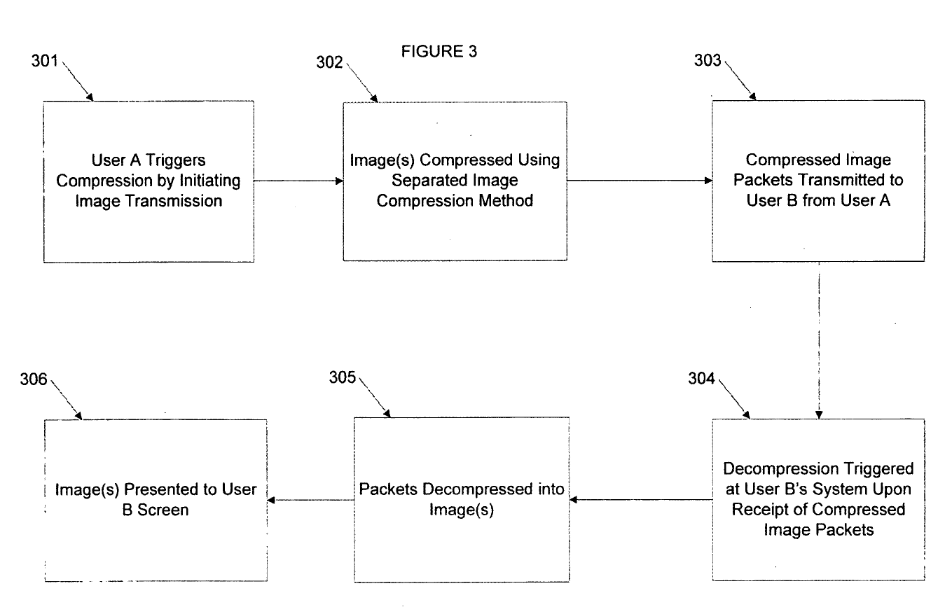

FIG. 3 is a flow diagram for an exemplary image transmission process within a separated image compression system, according to one embodiment. A user A triggers image encoding and compression by initiating the transfer of an image 301. Image encoding and compression are carried out according to a separated image compression method 302, an exemplary separated image compression method is depicted in FIG. 1.

The compressed image packets are transmitted from user A to user B 303, and decompression is triggered when the packets are received by user B 304. The compressed packets are decompressed into image blocks, using a reverse process as was used in compression 305. The image is then rendered on user B's screen 306. The exemplary embodiment shown in FIG. 3 depicts transmission between two users, however it should be understood by one skilled in the art that transmission and receipt of an image can occur between multiple users in other embodiments.

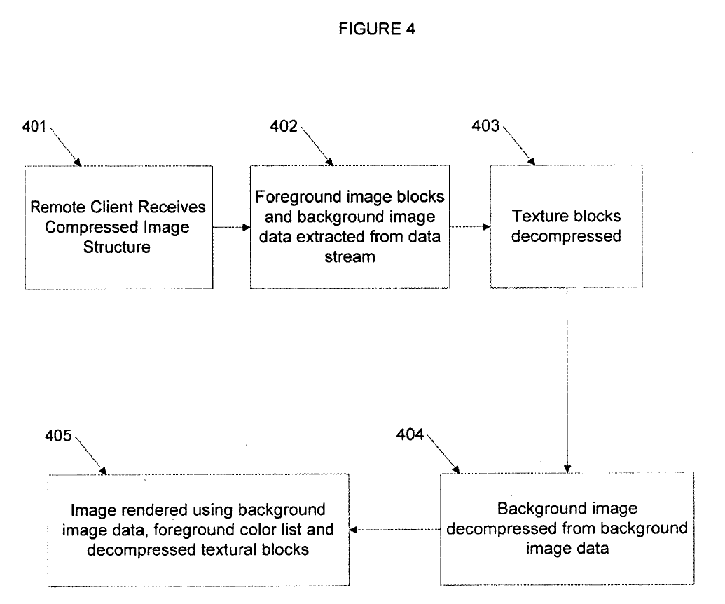

FIG. 4 is a flow diagram for an exemplary decoding process within a separated image compression system, according to one embodiment. A remote client receives packets containing encoded and compressed image data 401 and decoding is initiated. Foreground image blocks and compressed background image data are extracted from the packet data stream 402. Extracted texture blocks are decompressed 403 and background image data is decompressed 404. Decompression is achieved through reversing the compression process. Using background image data, textural blocks, and foreground color data the image is rendered on a recipient's screen 405.

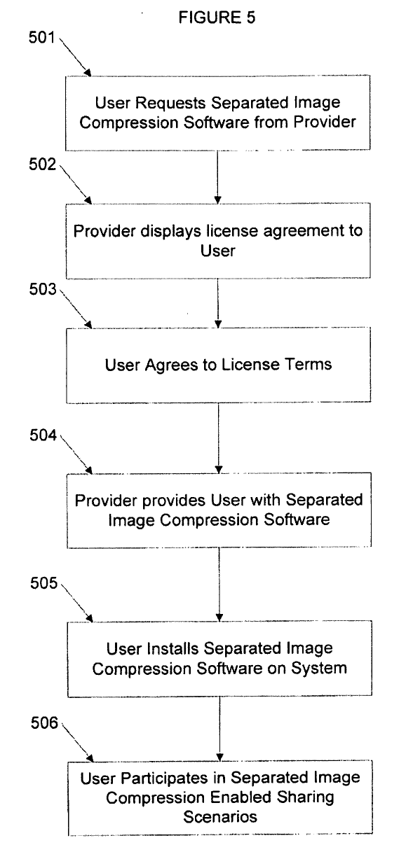

FIG. 5 is a flow diagram for establishing a relationship between a user system and a provider within a separated image compression system, according to one embodiment. A user requests separated image compression software from a provider 501. The provider provides (through pop-up display or email or other form of communication) a license agreement to the user 502, and the user agrees to the license terms 503. The provider provides (through any form of communication) the user with separated image compression software 504 and the separated image compression software is installed on the user system 505. After successful installation the user can participate 506 in separated image compression sharing situations.

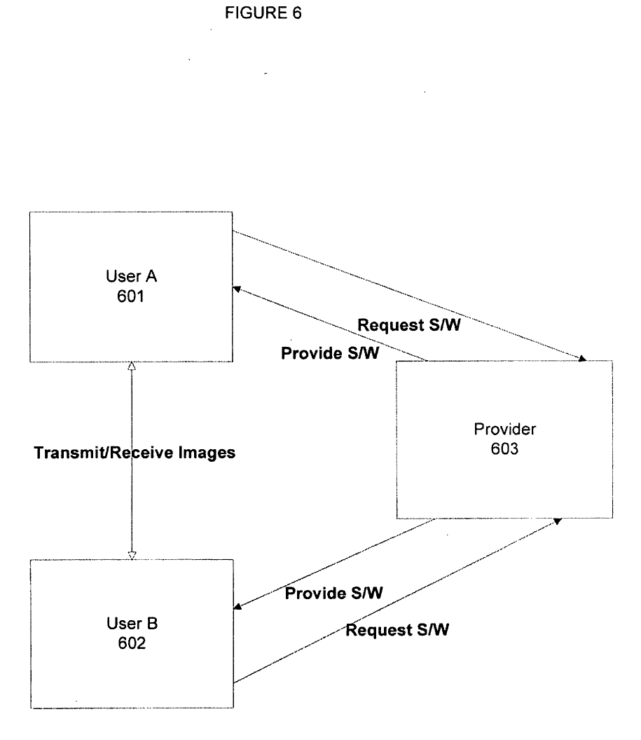

FIG. 6 is a system level diagram of users and a provider in an exemplary separated image compression system, according to one embodiment. User A 601 requests separated image compression software from a provider 603 and the provider provides separated image compression software to user A 601. Similarly, a user B 602 requests separated image compression software from a provider 603 and the provider provides separated image compression software to user B 602. Both user A 601 and user B 602 have separated image compression software installed on their systems and are able to share images using a system for separated image compression. The exemplary embodiment shown in FIG. 6 depicts transmission between two users, however it should be understood by one skilled in the art that transmission and receipt of an image can occur between multiple users in other embodiments.

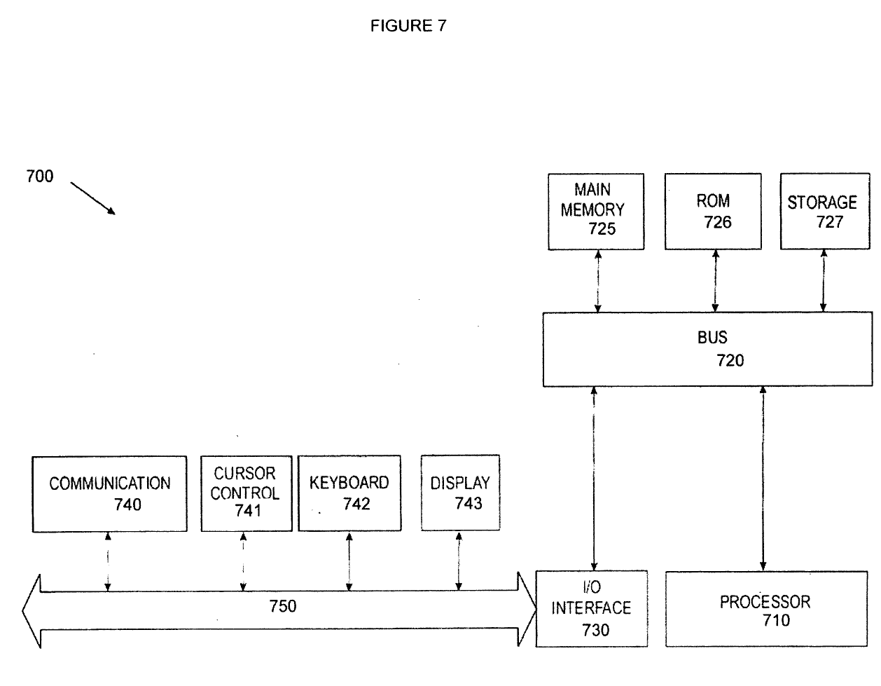

FIG. 7 illustrates an exemplary computer architecture for use with the present system, according to one embodiment. One embodiment of architecture 700 comprises a system bus 720 for communicating information, and a processor 710 coupled to bus 720 for processing information. Architecture 700 further comprises a random access memory (RAM) or other dynamic storage device 725 (referred to herein as main memory), coupled to bus 720 for storing information and instructions to be executed by processor 710. Main memory 725 also may be used for storing temporary variables or other intermediate information during execution of instructions by processor 710. Architecture 700 also may include a read only memory (ROM) and/or other static storage device 726 coupled to bus 720 for storing static information and instructions used by processor 710.

A data storage device 727 such as a magnetic disk or optical disc and its corresponding drive may also be coupled to computer system 700 for storing information and instructions. Architecture 700 can also be coupled to a second I/O bus 750 via an I/O interface 730. A plurality of I/O devices may be coupled to I/O bus 750, including a display device 743, an input device (e.g., an alphanumeric input device 742 and/or a cursor control device 741).

The communication device 740 allows for access to other computers (servers or clients) via a network. The communication device 740 may comprise one or more modems, network interface cards, wireless network interfaces or other well known interface devices, such as those used for coupling to Ethernet, token ring, or other types of networks.

A method and system for separated image compression are disclosed. It is understood that the embodiments described herein are for the purpose of elucidation and should not be considered limiting the subject matter of the present embodiments. Various modifications, uses, substitutions, recombinations, improvements, methods of productions without departing from the scope or spirit of the present invention would be evident to a person skilled in the art.

We claim:

1. A computer-implemented method, comprising:
initiating transfer of a screen image;
preparing the screen image for separation;
separating the screen image into image blocks;
compressing the image blocks into image packets; and
transmitting the image packets.

2. The computer-implemented method of claim 1, wherein preparing the screen image for separation comprises one or more of transforming the image color space, calculating a pixel gradient, and calculating a peak density.

3. The computer-implemented method of claim 1, wherein image blocks comprise foreground image blocks.

4. The computer-implemented method of claim 1, wherein image blocks comprise background image blocks.

5. The computer-implemented method of claim 1, wherein image packets comprise a foreground color list.

6. The computer-implemented method of claim 1, wherein image packets comprise merged texture block data.

7. A computer-implemented method, comprising:
receiving image packets;
extracting image blocks from the image packets;
decompressing the image blocks into a screen image; and
displaying the screen image.

8. The computer-implemented method of claim 7, wherein image blocks comprise foreground image blocks.

9. The computer-implemented method of claim 7, wherein image blocks comprise background image blocks.

10. The computer-implemented method of claim 7, wherein image packets comprise a foreground color list.

11. The computer-implemented method of claim 7, wherein image packets comprise merged texture block data.

12. A computer-readable medium having stored thereon a plurality of instructions, said plurality of instructions when executed by a computer, cause said computer to perform:
initiating transfer of a screen image;
preparing the screen image for separation;
separating the screen image into image blocks;
compressing the image blocks into image packets; and
transmitting the image packets.

13. The computer-readable medium of claim 12, wherein preparing the screen image for separation comprises one or more of transforming the image color space, calculating a pixel gradient, and calculating a peak density.

14. The computer-readable medium of claim 12, wherein image blocks comprise foreground image blocks.

15. The computer-readable medium of claim 12, wherein image blocks comprise background image blocks.

16. The computer-readable medium of claim 12, wherein image packets comprise a foreground color list.

17. The computer-readable medium of claim 12, wherein image packets comprise merged texture block data.

18. A computer-readable medium having stored thereon a plurality of instructions, said plurality of instructions when executed by a computer, cause said computer to perform:
receiving image packets;
extracting image blocks from the image packets;
decompressing the image blocks into a screen image; and
displaying the screen image.

19. The computer-readable medium of claim 18, wherein image blocks comprise foreground image blocks.

20. The computer-readable medium of claim 18, wherein image blocks comprise background image blocks.

21. The computer-readable medium of claim 18, wherein image packets comprise a foreground color list.

22. The computer-readable medium of claim 18, wherein image packets comprise merged texture block data.
